(19) United States
(12) Patent Application Publication
(10) Pub. No.: US 2006/0228166 A1
(43) Pub. Date: Oct. 12, 2006

(54) BALL HOLDING, LATCHING AND LOCKING APPLICATIONS USING RADIAL AND AXIAL SPRINGS

(75) Inventor: PETER J. BALSELLS, Newport Beach, CA (US)

Correspondence Address: Walter A. Hackler, Suite B, 2372 S.E. Bristol Street, Newport Beach, CA, 92660-0750, US

(73) Assignee: Bal Seal Engineering Co., Inc.

(21) Appl. No.: 11/278,372

(22) Filed: Mar. 31, 2006

Related U.S. Application Data
(60) Provisional application No. 60/668,309, filed on Apr. 5, 2005.

(51) Int. Cl. F16C 11/06

(52) U.S. Cl. 403/57; 403/122

(57) ABSTRACT

A latching mechanism includes a housing with a cavity therein with an opening thereto. A ball having a stem of smaller diameter extending from the ball. The ball is sized for insertion into the housing cavity through the opening. At least one groove in the housing cavity is disposed proximate the cavity opening and a coil spring is disposed in the groove and retains the ball for rotation within the cavity with the stem at selected conical angles.

The present application claims priority from the U.S. Provisional Patent Application Ser. No. 60/668,309 filed Apr. 5, 2005, which is to be incorporated herein in its entirety including all specification and drawings.

The present invention generally relates to latching components and is more particularly related to latching of a spherical component to enable both rotation and conical motion.

Canted coil springs have been used extensively and latching applications primarily in connectors that require longitudinal and rotating movement. The present application furthers the use of canted coil springs by their utilization in a latching mechanism having a ball and socket arrangement.

Connectors used in holding applications have been described extensively, as for example, U.S. Pat. Nos. 4,974,821, 5,139,276, 5,082,390, 5,545,842, 5,411,348 to Balsells, and others. All of these patents are to be incorporated herewith by this specific references thereto.

Of these cited U.S. Patents, U.S. Pat. No. 4,974,821 generally describes canted coil springs and a groove for orienting the spring for major axis radial loading for enabling a specific preselected characteristic in response to loading of the spring.

U.S. Pat. No. 5,082,390 teaches a canted coil spring for holding and locking a first and second number to one another.

U.S. Pat. No. 5,139,276 discloses a radially loaded spring in a groove for controlling resilient characteristics of the spring.

U.S. Pat. Nos. 5,411,348 and 5,545,842 teach spring mechanisms which preferentially lock two members together.

None of the cited references or any prior art provides for enabling conical movement of a ball.

### SUMMARY OF THE INVENTION

A latching mechanism in accordance with the present invention generally includes a housing having a cavity therein with an opening thereto. A ball, sized for insertion into a housing cavity through the opening, includes a stem having a smaller diameter than the ball from which it extends.

At least one groove in the housing cavity is provided proximate the cavity opening and a coil spring is disposed in the groove which retains the ball for rotation from the cavity with the stem at selected conical angles with respect to a housing centerline.

In one embodiment, the groove is circumferential and the coil spring is a continuous garter type spring. In another embodiment, a plurality of arcuate grooves are provided in the housing cavity and arcuate coil spring segments are disposed in each of the arcuate grooves.

A plurality of spaced apart circumferential grooves may be utilized in the housing cavity with a continuous garter coil spring disposed in each of the grooves which enables positioning the ball at different lateral positions within the housing.

In one embodiment, the groove and the spring are configured for locking the ball within the housing cavity and still another embodiment of the present invention the cavity is spherical. In this embodiment, two grooves may be disposed in the housing cavity with coil springs therein with the grooves being disposed on opposite hemispheres of the ball.

### BRIEF DESCRIPTION OF THE DRAWINGS

The advantages and features of the present invention will be better understood with the following description when considered in conjunction with the accompanying drawings, of which:

FIG. 1 is a side view of a mechanism in accordance with the present invention, in partial cross section, generally showing a housing and a cavity therein with an opening thereto along the ball inserted therein having a stem extending therefrom along with a groove in the housing cavity proximate the cavity opening the coil spring disposed in the groove for retaining the ball for rotation and conical movement within the cavity;

FIG. 2 is a view similar to FIG. 1 of an embodiment of the present invention utilizing a different groove configuration and also illustrating the decoupling of the ball from the housing cavity;

FIG. 3 is a cross sectional view of the present invention illustrating one embodiment of the present invention in which arcuate grooves and arcuate coil spring segments are utilized;

FIG. 4 is a cross sectional view of another embodiment of the present invention illustrating the use of a continuous circumferential groove and continuous garter type coil spring;

FIG. 5 illustrates yet another embodiment of the present invention utilizing a plurality of springs and grooves;

FIG. 5A illustrates a specific groove and a coil spring configuration for enabling of movement in a lateral direction within the housing cavity;

FIG. 6 illustrates the ball being positioned between the two of the grooves and springs;

FIG. 7 illustrates yet another position of the ball within the cavity;

FIG. 7A illustrates a groove and spring configuration for locking the ball within the cavity to prevent removal therefrom; and

FIG. 8 is a cross sectional view of yet another embodiment of the present invention utilizing two grooves and coil springs along with a cavity having a spherical shaped portion.

### DETAILED DESCRIPTION

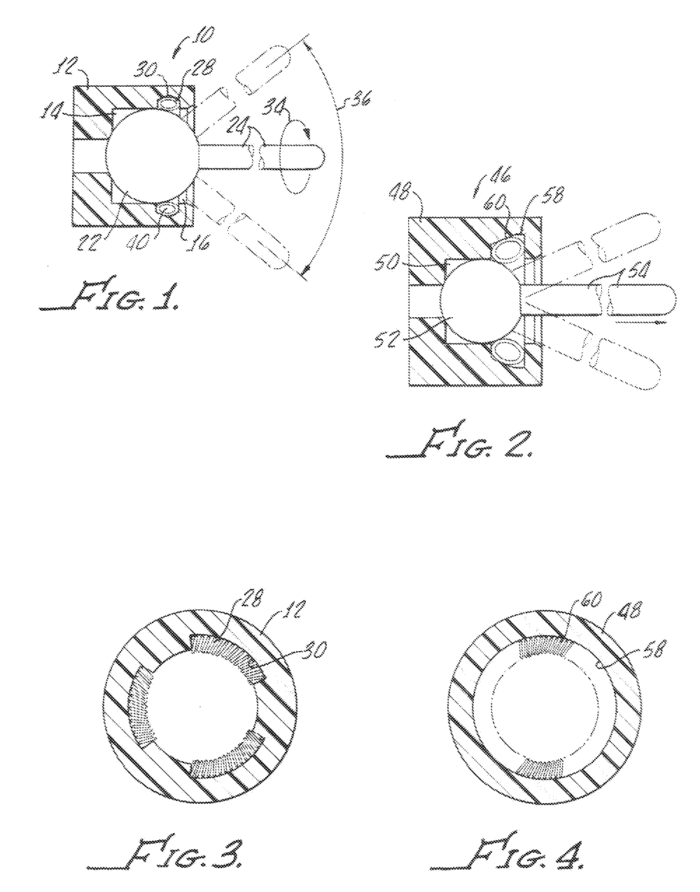

With reference to FIG. 1, there is shown a latching mechanism 10 in accordance with the present invention generally including a housing 12 having a cavity 14 therein with an opening 16. A ball 22 having a stem 24 extending therefrom is disposed within the cavity 14 with the ball 22 being sized for insertion into the housing cavity 14 through the opening 16 as illustrated. A radial canted coil spring 28 is disposed in a v-groove 30 for retaining the ball 22 for rotation within the cavity 14 with the stem at selected conical angles illustrated by the arrows 34, 36 in FIG. 1. Suitable springs and grooves for providing specific pre-selected characteristics are described in the hereinabove referenced U.S. Patents which are incorporated herewith by reference.

Briefly, the spring 28 is retained in the cavity 30 and a radial force is applied along a minor axis 40 onto the coil spring 28. The spring 28 is initially retained in the cavity by a spring OD larger than the ID of the cavity 14 thus creating a force that retains the spring within the cavity 14. The groove width (GW) is larger than the coil width (GW) of the spring (GW>CW). This type of design generates a ratio of connect to disconnect at approximately 1 to 1. Other configurations considered part of the present invention are described in the hereinabove referenced U.S. Patents.

The force required to insert and disconnect the ball 22 from the housing 12 is affected by the contact angle with the greater the contact angle the lower the force required to connect or disconnect. Such contact angle is determined by the groove configuration.

With records to FIG. 2, alternative embodiment 46 includes a housing 48 with cavity 50 with a ball 52 inserted thereinto with an extending stem 54 utilizing a different groove 58 configuration which includes a tapered bottom. The groove width at the bottom is smaller than the groove coil width illustrating another method in which the spring 60 can be retained in the groove 58 and cavity 50 with the forces to insert and disconnect being variable requiring more force to connect and to disconnect and due to the geometry of the groove and spring assembly. Again, further detach of spring are groove configuration may be found in the incorporated U.S. patents.

As illustrated in FIGS. 3 and 4, a coil spring 28 may comprise an arc segment and correspondingly the groove 30 is also an arc segment whereas, as shown in FIG. 4, the coil spring 60 may be continuous with the groove 58 also being circumferential and continuous within the cavity 50.

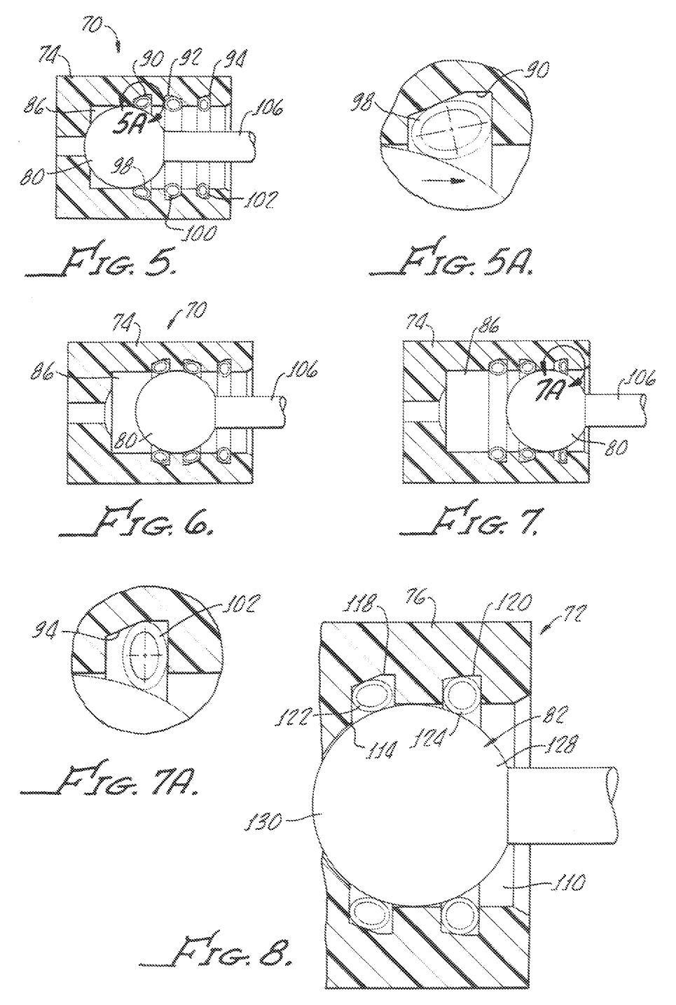

The materials of construction for the embodiment 10, 46, as well as 70, illustrated in FIGS. 5, 6, and 7 and embodiment 72 shown in FIG. 8 include housings 12, 48, 74, and 76 formed of a suitable rigid material such as metal, or the like, with the same being true for the balls 22, 52, and 80, 82.

Specific reference to FIGS. 5, 6, and 7, the housing 72 includes a cavity 86 including three spaced apart grooves for supporting springs 98, 100, 102, thus enabling the lateral positioning of the ball 80 within the cavity 86, as illustrated progressively in FIGS. 5, 6, and 7. Various spring and groove configurations may be utilized to control the connect and disconnect forces. As illustrated in FIG. 5a, the groove 90 and spring configuration enables passage of the ball 80 thereby along with the stem, whereas the groove 94 and spring configuration 102 shown in FIG. 7a lock the ball 80 to prevent disconnect from the housing cavity 86.

The embodiment 72 shown in FIG. 8 utilizes a cavity 110 having a spherical inside shape 114 and further includes two grooves 118, 120 with springs 122, 124 therein to provide greater retaining force on the ball 82 with the groove 118 and spring 122, then groove 120 and spring 122 being disposed on opposite or opposing hemispheres 128, 130 of the ball 82.

Although there has been hereinabove described a specific ball holding, latching, and locking applications using radial and axial springs in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. A latching mechanism comprising:
a housing having a cavity therein with an opening thereto;
a ball having a stem of smaller diameter than said ball and extending therefrom, said ball being sized for insertion into the housing cavity through said opening;
at least one groove in the housing cavity proximate the cavity opening;
a coil spring disposed in the groove and retaining said ball for rotation within said cavity with said stem at selected conical angles with respect to a housing centerline.

2. The mechanism according to claim 1 wherein said groove is circumferential and said coil spring is a continuous garter type spring.

3. The mechanism according to claim 1 wherein a plurality of arcuate grooves are disposed in the housing cavity and an arcuate coil spring segment is disposed in each of the arcuate grooves.

4. The mechanism according to claim 1 wherein a plurality of spaced apart circumferential grooves are disposed in the housing cavity with a continuous garter coil spring disposed in each groove enabling positioning of said ball at different lateral positions within said housing.

5. The mechanism according to claim 1 wherein the groove and spring are configured for locking said ball within the housing cavity.

6. The mechanism according to claim 1 wherein a portion of said cavity is spherical.

7. The mechanism according to claim 6 wherein two grooves are disposed in the housing cavity with a coil spring therein, the grooves being disposed an opposite hemispheres of said ball.

8. A latching mechanism comprising:
a housing having a cavity therein with an opening thereto;
a ball having a stem of smaller diameter than said ball and extending therefrom, said ball being sized for insertion into the housing cavity and removal therefrom through said opening;
at least one groove in the housing cavity proximate the cavity opening;
a coil spring disposed in the groove and retaining said ball within said cavity.

9. The mechanism according to claim 8 wherein said groove is circumferential and said coil spring is a continuous garter type coil spring.

10. The mechanism according to claim 8 wherein a plurality of arcuate grooves are disposed in the housing cavity and an arcuate coil spring segment is disposed in each of the arcuate grooves.

11. The mechanism according to claim 8 wherein a plurality of spaced apart circumferential grooves are disposed in the housing cavity with a continuous garter type coil spring disposed in each groove enabling positioning of ball at different lateral position within the housing.

12. The mechanism according to claim 8 wherein a portion of said cavity is spherical.

13. The mechanism according to claim 12 wherein a portion of said cavity is spherical.

14. The mechanism according to claim 8 wherein the groove and spring are configured for locking said ball within the housing cavity.
